(19) United States
(12) Patent Application Publication
(10) Pub. No.: US 2006/0254801 A1
(43) Pub. Date: Nov. 16, 2006

(54) Shielded electrical transmission cables and methods for forming the same

(76) Inventor: Randall Dean Stevens, Lincolnton, NC (US)

Correspondence Address: David D. Beatty;Myers Bigel Sibley & Sajovec, P.A., P. O. Box 37428, Raleigh, NC, 27627, US

(21) Appl. No.: 11/139,845

(22) Filed: May 27, 2005

(51) Int. Cl. H01B 7/18

(52) U.S. Cl. 174/102 R

(57) ABSTRACT

A shielded electrical transmission cable includes an elongate inner conductor and an elongate shield member surrounding the inner conductor. The shield member is formed of at least one copper clad aluminum shield wire including a core including aluminum and a cladding surrounding the core and including copper.

### FIELD OF THE INVENTION

The present invention relates to electrical transmission cables and, more particularly, to shielded electrical transmission cables.

### BACKGROUND OF THE INVENTION

Electrical transmission cables such as communications cables often include one or more electrical conductors that serve as shield members to shield the cable from electromagnetic interference (EMI) and/or radio frequency interference (RFI). These conductors may also serve as signal conductors. A shield member may take the form of a plurality of fine gauge wires braided or served (i.e., wound) over a cable. It is known to use copper wires or, alternatively, aluminum wires. Copper may be advantageous because it produces relatively lower volume resistivity, lower transfer impedance, and lower signal loss in radio frequency cables as compared to aluminum. Also, copper may prevent galvanic reaction with an adjacent copper shielding tape. However, copper is significantly heavier and more costly than aluminum.

### SUMMARY OF THE INVENTION

According to embodiments of the present invention, a shielded electrical transmission cable includes an elongate inner conductor and an elongate shield member surrounding the inner conductor. The shield member is formed of at least one copper clad aluminum shield wire including a core including aluminum and a cladding surrounding the core and including copper.

According to further embodiments of the present invention, a method for forming a shielded electrical transmission cable includes surrounding an elongate inner conductor with an elongate shield member. The shield member is formed of at least one copper clad aluminum shield wire including a core including aluminum and a cladding surrounding the core and including copper.

Further features, advantages and details of the present invention will be appreciated by those of ordinary skill in the art from a reading of the figures and the detailed description of the embodiments that follow, such description being merely illustrative of the present invention.

### BRIEF DESCRIPTION OF THE DRAWINGS

FIG. 1 is a cut-away perspective view of a coaxial cable in accordance with embodiments of the present invention.

FIG. 2 is a cross-sectional view of a wire forming a part of a shield member forming a part of the coaxial cable of FIG. 1.

FIG. 3 is a cut-away perspective view of a coaxial cable in accordance with further embodiments of the present invention.

FIG. 4 is a cut-away perspective view of a twisted pair cable in accordance with further embodiments of the present invention.

FIG. 5 is a cross-sectional view of a wire according to further embodiments of the present invention for forming a shield member.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

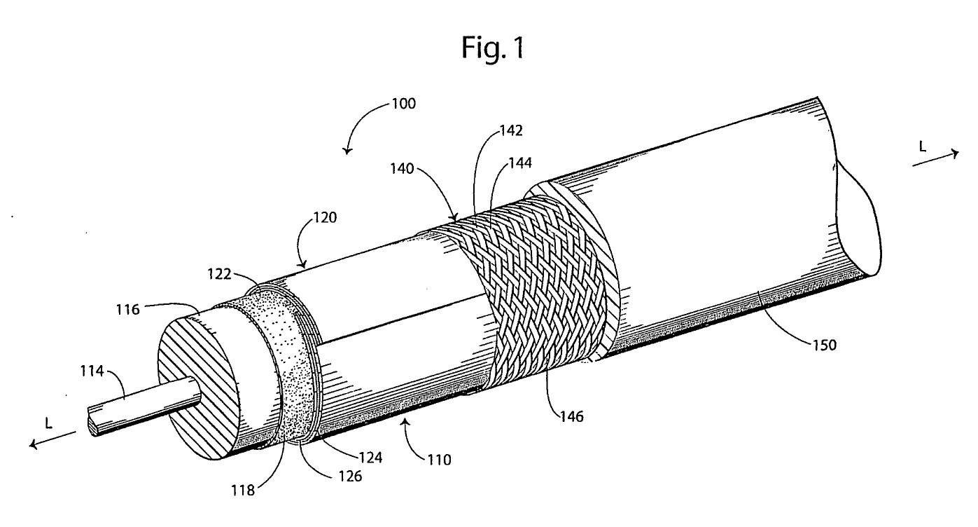

With reference to FIG. 1, a shielded electrical transmission cable 100 according to embodiments of the present invention is shown therein. The cable 100 is a coaxial cable. The cable 100 includes generally an electrically conductive elongate center or inner conductor 114, an insulation or dielectric layer 116, an adhesive layer 118, an electrically conductive first outer conductor or shield member 120, an electrically conductive second outer conductor or shield member 140, and an outer jacket 150. The shield members 120, 140 together form an EM/RFI shield 110. The shield 100 may shield the cable 100 from incident EMI and/or RFI and/or may prevent/inhibit signal egress from the cable 100, which may interfere with other equipment. According to some embodiments and as illustrated, the foregoing components are substantially concentrically positioned about and extend along a lengthwise axis L-L. These components will be described in more detail below. As discussed in more detail below, the shield member 140 includes a plurality of copper clad aluminum wires 142, 144 that are braided with one another to form a braided web.

The inner conductor 114 is typically formed of solid wire. It can be formed of any material that can conduct an electrical signal, but is preferably formed of solid copper, copper clad aluminum (CCA), silver coated copper or copper clad steel (CCS), with any of these materials being optionally plated with tin, silver or gold. Such plating can reduce the resistance of the inner conductor 114. In some embodiments, tempering of the copper, aluminum or steel under specific conditions during their formation can be carried out to enhance performance and/or impact conductivity. Also, when copper is employed as either the core material or as a cladding material, it may be preferred to use so-called “oxygen-free” copper, which is a commercially pure, high conductivity copper that has been produced in such a manner that it contains virtually no oxides or residual deoxidants. According to some embodiments, the conductor 114 has a diameter of between about 0.140 and 0.010 inch.

The dielectric layer 116 circumferentially surrounds the inner conductor 114. The dielectric layer 116 may be formed of any suitable polymeric material. According to some embodiments, the dielectric layer 116 is formed of a foamed fluorinated ethylene propylene (FEP). According to some embodiments, the thickness (i.e., from inner diameter to outer diameter) of the dielectric layer. 116 is between about 0.007 and 0.250 inch.

The first shield member 120 circumferentially surrounds the dielectric layer 116. According to some embodiments, and as shown, the shield member 120 is a laminated shielding tape that is applied such that the edges of the tape are either in abutting relationship or overlapping (as shown) to provide 100% shielding coverage. The shield member 120 as illustrated includes a pair of thin metallic foil layers 122 and 124 that are bonded to opposite sides of a polymeric layer 126. According to some embodiments, the polymeric layer 126 is a polyolefin (e.g., polypropylene) film or a polyester film. Each of the metal layers 122, 124 may be an aluminum foil layer (including aluminum alloys) or a copper foil layer, for example. Other suitable materials and/or more or fewer layers may be used to form the shield member 120.

As shown, the shield member 120 may be bonded to the dielectric layer 116 by a thin adhesive layer 118. Suitable adhesives for the adhesive layer 118 include low-density polyethylene, ethylene vinyl acetate (EVA), ethylene acrylic acid (EAA), and ethylene methylacrylate (EMA), and mixtures and formulations thereof. According to some embodiments and as shown, the shield member 120 is secured directly to the outer surface of the dielectric layer 116 by the adhesive layer 118.

According to some embodiments, the shield member 120 has a total thickness (i.e., including the polymer layer 126 and all of the metallic foil layers 122, 124) of between about 1 and 4 mil. According to some embodiments, the metallic foil layers 122, 124 have a combined thickness of between about 3.0 and 0.035 mil. The two metallic layers 122, 124 may be replaced with a single metallic layer having a thickness in the same range.

The second shield member 140 circumferentially surrounds the shield member 120. As illustrated, the shield member 140 is a braided shield member or sheath formed by interlacing or braiding the plurality of stranded, electrically conductive wires 142 with the plurality of stranded, electrically conductive wires 144 so as to form a braided tubular web defining a plurality of voids 146 between the wires 142, 144. According to some embodiments, the voids 146 take the form of radially-extending through holes or picks as shown in FIG. 1.

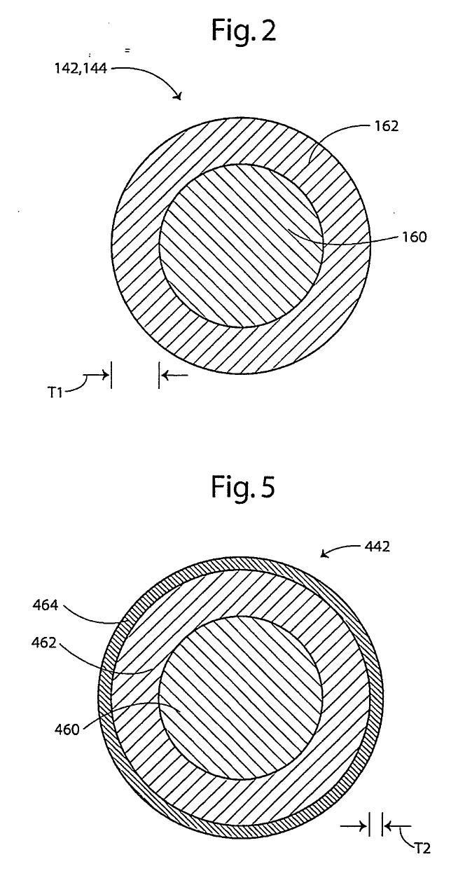

FIG. 2 shows a cross-sectional view of an exemplary one of the wires 142, 144. Each wire 142, 144 includes an elongate core 160 including aluminum and an elongate cladding layer 162 including copper. The cladding layer 162 substantially fully surrounds the core 160 about the length axis of the wire 142, 144. According to some embodiments, the copper cladding 162 is bare.

According to some embodiments, the cladding 162 is formed of solid or unalloyed copper (i.e., at least 99.9% pure). According to some embodiments, the cladding 162 is formed of copper alloy. Materials that may be alloyed with the copper include tin, lead, or zinc.

According to some embodiments, the core 160 is formed of solid or unalloyed aluminum (ie., at least 99.0% pure). According to some embodiments, the core 160 is formed of an aluminum alloy. Materials that may be alloyed with the aluminum include iron, silicon, and copper.

According to some embodiments and as illustrated, the wire 142, 144 is a round wire. According to some embodiments, the core 160 and the cladding 162 are substantially concentric. According to some embodiments, the core 160 is substantially uniform in diameter and the cladding 162 is substantially uniform in thickness.

According to some embodiments, the copper cladding 162 forms between about 8 and 17 volume percent of the wire 142, 144. According to some embodiments, the wire 142, 144 complies with at least one of the following ASTM B566, “Specification for Copper Clad Aluminum”, standards: Type 10 H (10% by volume copper, Hard Drawn); Type 15 H (15% by volume copper, Hard Drawn); Type 10 A (10% by volume copper, Annealed); and Type 15 A (15% by volume copper, Annealed). According to some embodiments, the wire 142, 144 has an overall nominal diameter no greater than about 0.010 inch. According to some embodiments, the wires have an AWG size of between about 30 and 42.

According to some embodiments, the thickness T1 of the cladding 162 is between about 0.00017 and 0.0031 inch. According to some embodiments, the thickness T1 is between about 3.5 and 4.5 percent of the radius of the wire 142, 144.

According to some embodiments, the percent coverage (i.e., the percent of the cable actually covered by the wires 142, 144 of the braided shield member 140, not including the areas of the cable beneath the voids 146) of the shield member 140 is at least about 30%. According to some embodiments, the percent coverage is between about 30 and 98%.

The jacket 150 circumferentially surrounds the shield member 140 and is typically formed of a polymeric material, which may be the same as or different from that of the dielectric layer 116. Exemplary materials include polyvinyl chloride (PVC), fluoropolymers, and co-polymers and blends thereof. According to some embodiments, PVC is preferred. The jacket 150 should be formed of a material that can protect the internal components from external elements (such as water, dirt, dust and fire) and from physical abuse. The material of the jacket 150 may include additives, such as carbon black, to enhance UV resistance. According to some embodiments, the jacket 150 has a thickness of between about 0.010 and 0.060 inch. In some embodiments, the jacket 150 is bonded to the shield member 140 with an adhesive (not shown); exemplary adhesives are as described above. Typically, however, the jacket 150 is not bonded to the shield member 140.

The shield member 140 may provide certain advantages as compared to braided shield members of conventional design, for example. The wires 142, 144 may be of substantially the same overall gauge as solid copper wires, but will be lighter in weight because of their aluminum content (i.e., the aluminum core 160). Such lighter weight may provide substantial savings in cost. If the foil layer 124 that engages the shield member 140 is formed of copper, the copper layer 162 of the wires 142, 144 will prevent galvanic reaction with the foil layer 124.

The wires 142, 144 and the shield member 140 may nonetheless provide equivalent or substantially equivalent EMI/RFI shielding and/or signal transmission performance as a shield member formed with solid copper wires. This may be attributable to the skin effect, whereby current in high frequency electrical signals and EM/RFI travel substantially on or near the surface of a conductor. In the wires 142, 144, the currents may travel entirely or predominantly in the copper layer 162 so that the wires 142, 144 carry the RF currents as effectively as a solid heavy copper shielding wire wherein the currents would travel entirely or predominantly in the same region.

The copper clad aluminum wires 142, 144 may also facilitate stripping of the cable 100 (i.e., progressively removing layers of the cable generally as illustrated in FIG. 1) to allow for connectorizing of the cable 100, etc. It has been found that a shield member 140 as described herein may be more effectively cut or scored than a comparable shield member formed of stranded solid copper wires.

With reference to FIG. 3, a coaxial cable 200 according to further embodiments of the present invention is shown therein. The cable 200 is constructed in the same manner as the cable 100 except that the shield member 140 is replaced with a shield member or conductor 240. The shield member 240 includes a plurality of wires 242 helically wound or served in parallel to form a shielding layer. The wires 242 are constructed in the same manner as described above with regard to the wires 142, 144. According to some embodiments, the shield member 240 has a percent coverage as described above for the shield member 140.

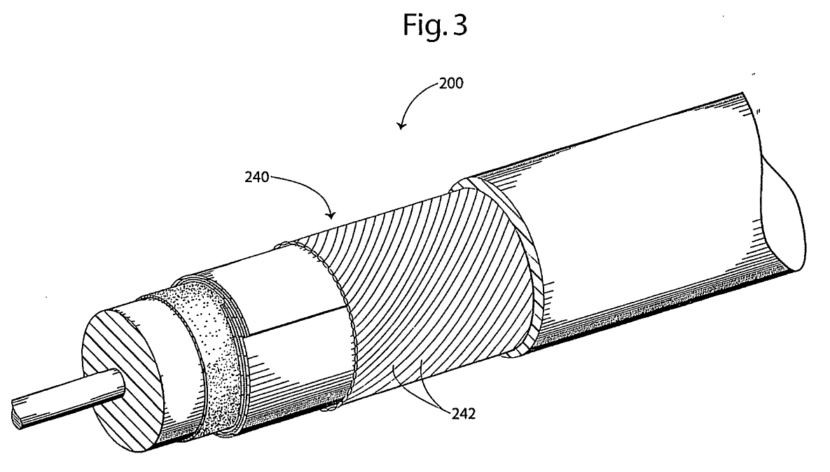

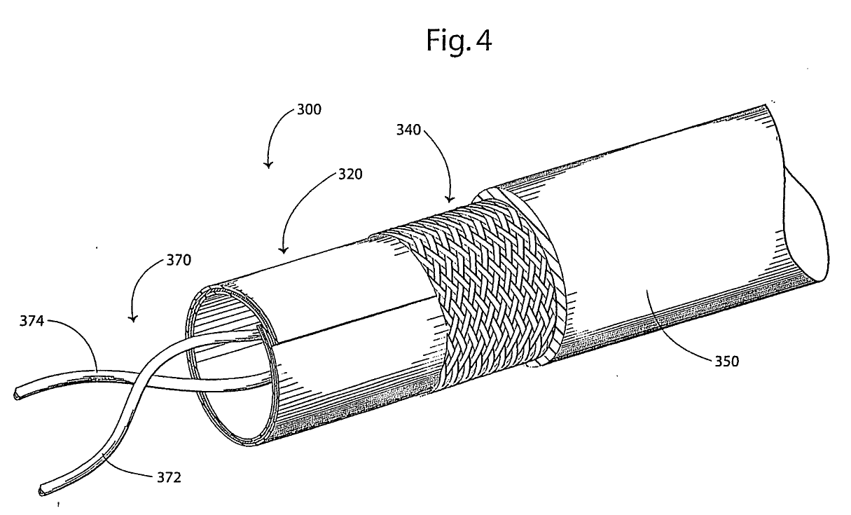

With reference to FIG. 4, a multi-conductor electrical transmission cable 300 according to further embodiments of the present invention is shown therein. The cable 300 includes a pair of insulated conductors 372, 374 that are twisted about one another (to form a twisted wire pair 370). A first shield member 320, a second shield member 340, and a jacket 350 surround the twisted wire pair 370. The first shield member 320, the second shield member 340, and the jacket 350 correspond to and may be constructed in the same manner as the shield member 120, the shield member 340, and the jacket 350, respectively, of the coaxial cable 100.

The cable 300 may be modified to include additional twisted wire pairs, or may include one or more non-twisted insulated conductors in addition to or in place of the twisted wire pair 370. According to further embodiments, the second shield member 340 may be a helically wound shield member corresponding to the shield member 240 rather than a braided shield member.

The cables 100, 200, 300 may triple-shielded or quad-shielded. That is, one or more additional shield members may be provided over or under the shield member 140, 240, 340. For example, a further shield member constructed in the same manner as the shield member 240 can be counterwound over or under the shield member 240. According to some embodiments, the first shield member (e.g., the shield member 120, 220 or 320) may be omitted.

While braided and helically wound shield members incorporating copper clad aluminum wires have been described herein, according to further embodiments, copper clad aluminum wires may be otherwise configured. For example, the copper clad aluminum wires may be longitudinal or woven.

With reference to FIG. 5, a wire 442 according to further embodiments of the present invention is shown therein. The wire 442 is formed in the same manner as described above with regard to the wires 142, 144 except that the wire 442 further includes an outermost layer 464 of tin over the aluminum containing core 460 and the copper cladding 462. That is, the wire 442 is a tinned, copper clad aluminum wire. According to some embodiments, the wire 442 is used in place of the copper clad aluminum wires described above (e.g., the wires 142, 144, 242) to form a shield member (e.g., the shield members 140, 240, 340). The tinned wire 442 may be advantageously employed when the shield member will be in contact with aluminum to avoid undesirable reaction between the copper of the cladding 462 and the aluminum surface. For example, the metal foil 124 (FIG. 1) may be formed of aluminum.

According to some embodiments, the tin layer 464 forms a thin, continuous coating having a nominal thickness T2 that is less than about 0.00032 inch.

Cables as described herein may be formed in the same manner as known cables of similar construction. The copper clad aluminum wires or tinned copper clad wires may be a direct replacement for copper wires utilizing the same application methods, braiding machines, servers or bunchers, etc., that are conventionally or suitably employed for the application of copper wire shielding. Any suitable method and apparatus may be used to form the wires 142, 144. Suitable methods and apparatus will be apparent to those of skill in the art. Accordingly, methods for forming cables according to the present invention will be readily apparent to those skilled in the art upon reading the description herein.

Electrical transmission cables according to embodiments of the present invention (e.g., the cables 100, 200, 300) may be used as communications or electronic cables. Cables of other types and constructions may also be formed in accordance with embodiments of the invention.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A shielded electrical transmission cable comprising:
a) an elongate inner conductor; and
b) an elongate shield member surrounding the inner conductor, wherein the shield member is formed of at least one copper clad aluminum shield wire including a core including aluminum and a cladding surrounding the core and including copper.

2. The cable of claim 1 wherein the shield member is a braided shield member including a plurality of the shield wires braided with one another.

3. The cable of claim 2 wherein the braided shield member defines a plurality of voids between the shield wires and has a percent coverage of between about 30 and 98 percent.

4. The cable of claim 1 wherein the shield member includes a plurality of the shield wires helically wound about the elongate inner conductor.

5. The cable of claim 1 wherein each shield wire includes between about 8 and 17 volume percent copper.

6. The cable of claim 1 wherein the core of each shield wire is formed of an aluminum alloy.

7. The cable of claim 1 wherein each of the shield wires has an overall nominal diameter no greater than about 0.010 inch.

8. The cable of claim 1 wherein each of the shield wires includes an outer tin layer surrounding the cladding.

9. The cable of claim 1 including a second shield member surrounding the inner conductor and disposed adjacent and in contact with the first shield member.

10. The cable of claim 1 including a polymeric jacket surrounding the shield member.

11. The cable of claim 1 wherein:
the cable is a coaxial cable including a dielectric layer surrounding the inner conductor; and
the shield member surrounds the dielectric layer.

12. The cable of claim 1 wherein the cable is a multi-conductor cable including a second elongate inner conductor, wherein the shield member surrounds each of the first and second inner conductors.

13. The cable of claim 12 wherein the first and second inner conductors each include a respective insulating layer and are twisted with one another to form a twisted wire pair.

14. A method for forming a shielded electrical transmission cable, the method comprising:
surrounding an elongate inner conductor with an elongate shield member, wherein the shield member is formed of at least one copper clad aluminum shield wire including a core including aluminum and a cladding surrounding the core and including copper.

15. The method of claim 14 including braiding a plurality of the shield wires with one another to form the shield member.

16. The method of claim 15 wherein the shield member defines a plurality of voids between the shield wires and has a percent coverage of between about 30 and 98 percent.

17. The method of claim 14 including winding a plurality of the shield wires helically about the elongate inner conductor to form the shield member.

18. The method of claim 14 wherein each shield wire includes between about 8 and 17 volume percent copper.

19. The method of claim 14 wherein the core of each shield wire is formed of an aluminum alloy.

20. The method of claim 14 wherein each of the shield wires has an overall nominal diameter no greater than about 0.010 inch.

21. The method of claim 14 wherein each of the shield wires includes an outer tin layer surrounding the cladding.

22. The method of claim 14 including surrounding the inner conductor with a second shield member such that the second shield member is disposed adjacent and in contact with the first shield member.

23. The method of claim 14 including surrounding the shield member with a polymeric jacket.

24. The method of claim 14 including surrounding the inner conductor with a dielectric layer and surrounding the dielectric layer with the shield member.

25. The method of claim 14 including surrounding each of the first inner conductor and a second inner conductor with the shield member.

26. The method of claim 25 including twisting the first and second inner conductors about one another to form a twisted wire pair, wherein each of the first and second inner conductors includes a respective insulating layer.

27. The cable of claim 9 wherein the second shield member is interposed between the inner conductor and the first shield member.

28. The method of claim 22 including interposing the second shield member between the inner conductor and the first shield member.

29. The cable of claim 1 wherein the cable is a radio frequency cable and the shield member provides radio frequency shielding.
